(19) United States
(12) Patent Application Publication
(10) Pub. No.: US 2026/0310876 A1
(43) Pub. Date: Oct. 8, 2026

(54) FONT STYLE MIGRATION NETWORK TRAINING METHOD AND APPARATUS, DEVICE, AND STORAGE MEDIUM

(71) Applicant: BOE Technology Group Co., Ltd., Beijing (CN)

(72) Inventors: Xianbin LIU, Beijing (CN); Zhanfu AN, Beijing (CN)

(21) Appl. No.: 18/996,877

(22) PCT Filed: Jan. 4, 2023
(86) PCT No.: PCT/CN2023/070329

§ 371 Date: Jan. 17, 2025

(51) Int. Cl. G06F 40/109; G06F 3/04883; G06N 3/0455; G06N 3/09

(52) U.S. Cl. CPC G06F 40/109; G06F 3/04883; G06N 3/0455; G06N 3/09

(57) ABSTRACT

Disclosed in the present invention are a font style migration network training method and apparatus, a device, and a storage medium. The method comprises: obtaining a preset font style migration network, wherein the preset font style migration network is a generative adversarial network; obtaining a preset character image sample set, wherein the preset character image sample set comprises a plurality of first character image samples, and each first character image sample comprises a first original character image, sampling information of the first original character image, and a first target character image, the first original character image and the sampling information of the first original character image are sample features, and training the preset font style migration network by using the preset character image sample set to obtain a target font style migration network.

### TECHNICAL FIELD

The present disclosure relates to the field of machine learning technology, particularly to a method and an apparatus for training typeface style conversion network, a device, and a storage medium.

### BACKGROUND

With the popularization of computer technology, there are many business scenarios for displaying text, such as web front-end design, advertising packaging, handwriting screens, etc.

In actual display, text can usually have typeface styles, such as Song, Gothic, handwriting, etc. Different typeface styles can adapt to different display scenarios and improve the display effect. Typically, the typeface style can be adjusted for the text to enhance the display effect.

Existing methods can only set the typeface style based on the text's identifier, find the typeface image that represents the text in the corresponding style typeface library for display.

However, for character images where the text identifier cannot be directly determined, such as handwritten characters on a handwriting screen or characters in an image, it is often difficult to adjust the typeface style.

### SUMMARY

The present disclosure provides a method and an apparatus for training a typeface style conversion network, a device, and a storage medium, to address deficiencies in the related art.

According to a first aspect of the embodiments of the present disclosure, a method for training a typeface style conversion network is provided, including:
obtaining a preset typeface style conversion network, where the preset typeface style conversion network includes a generative adversarial network;
obtaining a preset character image sample set, where the preset character image sample set includes first character image samples, and each of the first character image samples includes a first original character image, sampling information of the first original character image, and a first target character image, where the first original character image and the sampling information of the first original character image serve as sample features, the first target character image serves as a sample label, and the first original character image and the first target character image in the same character image sample representing the same character; and
training the preset typeface style conversion network using the preset character image sample set to obtain a target typeface style conversion network.

In some embodiments, the preset character image sample set includes multiple first target character images representing the same character, where the multiple first target character images representing the same character respectively correspond to different first original character images.

In some embodiments, the preset typeface style conversion network includes a preset generative model and a preset discriminative model, where the preset generative model is configured to generate a conversion result image based on an original character image and sampling information of the original character image, and the preset discriminative model is configured to predict a probability that the conversion result image is a target character image.

In some embodiments, the sampling information includes position information of character sampling points and/or position information of character trajectories.

In some embodiments, the sampling information includes the position information of the character sampling points, and the sampling information further includes sequence information of the character sampling points; and/or the sampling information includes the position information of the character trajectories, and the sampling information further includes sequence information of the character trajectories.

In some embodiments, an obtaining method for the sampling information includes:
sampling writing trajectories of the first original character image to obtain the sampling information.

In some embodiments, sampling the writing trajectories of the first original character image to obtain the sampling information includes:
sampling the writing trajectories of the first original character image on a touch screen to obtain trajectories with a temporal sequence relationship; and determining the trajectories with the temporal sequence relationship as the sampling information.

In some embodiments, an obtaining method of the sampling information includes:
sampling the first original character image to obtain the sampling information.

In some embodiments, the preset generative model includes an image encoder, a sampling information encoder, and a decoder, and
the preset generative model is configured to: extract image features from an original character image by the image encoder; extract sampling information features from sampling information of the original character image by the sampling information encoder; perform channel concatenation on the image features and the sampling information features to obtain a channel concatenation result; and generate a conversion result image by the decoder based on the channel concatenation result.

In some embodiments, obtaining the preset typeface style conversion network includes:
obtaining a pre-trained initial typeface style conversion network, where the initial typeface style conversion network includes a generative adversarial network, and the generative adversarial network includes an initial generative model and an initial discriminative model,
where the initial generative model is configured to generate a second conversion initial image for a second original character image, and the initial discriminative model is configured to predict the probability that the second conversion initial image is a target character image; and
converting the initial typeface style conversion network into the preset typeface style conversion network including: adding a sampling information encoder to the initial generative model of the initial typeface style conversion network, where the sampling information encoder is configured to encode sampling information of an original character image, cascading an output of the sampling information encoder to an input of a decoder in the initial generative model to obtain the preset generative model, and determining the initial discriminative model as the preset discriminative model.

In some embodiments, where obtaining the pre-trained initial typeface style conversion network includes: training the initial typeface style conversion network to obtain the pre-trained initial typeface style conversion network;
where training the initial typeface style conversion network includes:
obtaining an initial character image sample set, where the initial character image sample set includes second character image samples, and each of the second character image samples includes a second original character image and a second target character image, where the second original character image serves as a sample feature, the second target character image serves as a sample label, and the second original character image and the second target character image in the same second character image sample represent the same character; and using the initial character image sample set to train the initial typeface style conversion network.

In some embodiments, the second original character image includes a character image in handwritten style, and
the second target character image includes a character image in printed typeface style.

In some embodiments, the multiple first target character images representing the same character have different typeface styles;
the preset generative model in the target typeface style conversion network is configured to: for inputs of different character images representing the same character, output conversion result character images with different typeface styles.

In some embodiments, an obtaining method for the character image samples in the preset character image sample set includes:
determining different character images representing the same character and having different typeface styles as multiple first target character images; and
according to the multiple first target character images, respectively obtaining sample features to obtain the first character image samples.

In some embodiments, according to the multiple first target character images, respectively obtaining the sample features includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image; or
for any one of the multiple first target character images, obtaining at least one character image of copied writing, determining the at least one character image as at least one first original character image, and determining sampling information for the at least one first original character image.

In some embodiments, the multiple first target character images representing the same character have different handwritten styles;
the preset generative model in the target typeface style conversion network is configured to: for inputs of different character images representing the same character, output conversion result character images with different handwritten styles.

In some embodiments, an obtaining method for character image samples in the preset character image sample set includes:
determining different character images representing the same character and having different handwritten styles as multiple first target character images, and
obtaining sample features respectively according to the multiple first target character images, to obtain the first character image samples.

In some embodiments, obtaining the sample features respectively according to the first target character images includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image;
for any one of the multiple first target character images, obtaining at least one character image of copied writing, determining the at least one character image as at least one first original character image, and determining sampling information for the at least one first original character image; or
for any one of the multiple first target character images, determining at least one character image obtained by handwriting a character represented by the first target character image in the same handwritten style as at least one first original character image, and determining sampling information for the at least one first original character image.

In some embodiments, an obtaining method for character image samples in the preset character image sample set includes:
obtaining different character images handwritten by different individuals for the same character,
where the different individuals have different handwritten styles, and for the same character, the number of character images obtained by handwriting the same character by the same individual based on the same handwritten style is greater than or equal to 2; and
determining any one of character images handwritten by the same individual as the first target character image, and determining other character images as first original character images, and determining sampling information for the first original character images, to obtain character image samples.

According to a second aspect of the present disclosure, an apparatus for training a typeface style conversion network is provided, including:
a network obtaining unit, configured to obtain a preset typeface style conversion network, where the preset typeface style conversion network includes a generative adversarial network;
a sample obtaining unit, configured to obtain a preset character image sample set, where the preset character image sample set includes first character image samples, and each of the first character image samples includes a first original character image, sampling information of the first original character image, and a first target character image, where the first original character image and the sampling information of the first original character image serve as sample features, the first target character image serves as a sample label, and the first original character image and the first target character image in the same character image sample representing the same character; and
a training unit configured to train the preset typeface style conversion network using the preset character image sample set to obtain a target typeface style conversion network.

In some embodiments, the preset character image sample set includes multiple first target character images representing the same character, where the multiple first target character images representing the same character respectively correspond to different first original character images.

In some embodiments, the preset typeface style conversion network includes a preset generative model and a preset discriminative model, where the preset generative model is configured to generate a conversion result image based on an original character image and sampling information of the original character image, and the preset discriminative model is configured to predict a probability that the conversion result image is a target character image.

In some embodiments, the sampling information includes position information of character sampling points and/or position information of character trajectories.

In some embodiments, the sampling information includes the position information of the character sampling points, and the sampling information further includes sequence information of the character sampling points; and/or
the sampling information includes the position information of the character trajectories, and the sampling information further includes sequence information of the character trajectories.

In some embodiments, an obtaining method for the sampling information includes:
sampling writing trajectories of the first original character image to obtain the sampling information.

In some embodiments, sampling the writing trajectories of the first original character image to obtain the sampling information includes:
sampling the writing trajectories of the first original character image on a touch screen to obtain trajectories with a temporal sequence relationship; and determining the trajectories with the temporal sequence relationship as the sampling information.

In some embodiments, an obtaining method of the sampling information includes:
sampling the first original character image to obtain the sampling information.

In some embodiments, the preset generative model includes an image encoder, a sampling information encoder, and a decoder, and
the preset generative model is configured to: extract image features from an original character image by the image encoder; extract sampling information features from sampling information of the original character image by the sampling information encoder; perform channel concatenation on the image features and the sampling information features to obtain a channel concatenation result; and generate a conversion result image by the decoder based on the channel concatenation result.

In some embodiments, the network obtaining unit is used for:
obtaining a pre-trained initial typeface style conversion network, where the initial typeface style conversion network includes a generative adversarial network, and the generative adversarial network includes an initial generative model and an initial discriminative model,
where the initial generative model is configured to generate a second conversion initial image for a second original character image, and the initial discriminative model is configured to predict the probability that the second conversion initial image is a target character image; and
converting the initial typeface style conversion network into the preset typeface style conversion network including: adding a sampling information encoder to the initial generative model of the initial typeface style conversion network, where the sampling information encoder is configured to encode sampling information of an original character image, cascading an output of the sampling information encoder to an input of a decoder in the initial generative model to obtain the preset generative model, and determining the initial discriminative model as the preset discriminative model.

In some embodiments, the network obtaining unit is used for: training the initial typeface style conversion network to obtain the pre-trained initial typeface style conversion network;
where, the network obtaining unit is used for:
obtaining an initial character image sample set, where the initial character image sample set includes second character image samples, and each of the second character image samples includes a second original character image and a second target character image, where the second original character image serves as a sample feature, the second target character image serves as a sample label, and the second original character image and the second target character image in the same second character image sample represent the same character; and
using the initial character image sample set to train the initial typeface style conversion network.

In some embodiments, the second original character image includes a character image in handwritten style, and
the second target character image includes a character image in printed typeface style.

In some embodiments, the multiple first target character images representing the same character have different typeface styles;
the preset generative model in the target typeface style conversion network is configured to: for inputs of different character images representing the same character, output conversion result character images with different typeface styles.

In some embodiments, an obtaining method for the character image samples in the preset character image sample set includes:
determining different character images representing the same character and having different typeface styles as multiple first target character images; and
according to the multiple first target character images, respectively obtaining sample features to obtain the first character image samples.

In some embodiments, according to the multiple first target character images, respectively obtaining the sample features includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image; or
for any one of the multiple first target character images, obtaining at least one character image of copied writing, determining the at least one character image as at least one first original character image, and determining sampling information for the at least one first original character image.

In some embodiments, the multiple first target character images representing the same character have different handwritten styles;
the preset generative model in the target typeface style conversion network is configured to: for inputs of different character images representing the same character, output conversion result character images with different handwritten styles.

In some embodiments, an obtaining method for character image samples in the preset character image sample set includes:
determining different character images representing the same character and having different handwritten styles as multiple first target character images, and
obtaining sample features respectively according to the multiple first target character images, to obtain the first character image samples.

In some embodiments, obtaining the sample features respectively according to the first target character images includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image;
for any one of the multiple first target character images, obtaining at least one character image of copied writing, determining the at least one character image as at least one first original character image, and determining sampling information for the at least one first original character image;
for any one of the multiple first target character images, determining at least one character image obtained by handwriting a character represented by the first target character image in the same handwritten style as at least one first original character image, and determining sampling information for the at least one first original character image.

In some embodiments, an obtaining method for character image samples in the preset character image sample set includes:
obtaining different character images handwritten by different individuals for the same character,
where the different individuals have different handwritten styles, and for the same character, the number of character images obtained by handwriting the same character by the same individual based on the same handwritten style is greater than or equal to 2; and
determining any one of character images handwritten by the same individual as the first target character image, and determining other character images handwritten by the same individual as first original character images, and determining sampling information for the first original character images, to obtain character image samples.

Based on the above embodiments, it is understood that by utilizing character image samples to train a preset typeface style conversion network, the trained preset typeface style conversion network can be used for typeface style conversion of character images, thereby facilitating the typeface style conversion of character images.

It should be understood that the foregoing general description and the below detailed description are merely exemplary and explanatory, and are not intended to limit the present disclosure.

### BRIEF DESCRIPTION OF DRAWINGS

The accompanying drawings are incorporated herein by reference and constitute a part of the present disclosure, illustrating embodiments consistent with the present disclosure and, together with the description, serve to explain the principles of the present disclosure.

FIG. 1 is a flowchart of a for training a typeface style conversion network according to embodiments of the present disclosure.

FIG. 2 is a schematic diagram of a structure of a preset typeface style conversion network according to embodiments of the present disclosure.

FIG. 3 is a flowchart of a typeface style conversion method according to embodiments of the present disclosure.

FIG. 4 is a schematic diagram of a principle of typeface style conversion according to embodiments of the present disclosure.

FIG. 5 is a schematic diagram of a structure of an apparatus for training a typeface style conversion network according to embodiments of the present disclosure.

FIG. 6 is a schematic diagram of a structure of an apparatus for training a typeface style conversion network according to embodiments of the present disclosure.

FIG. 7 is a schematic diagram of a hardware structure of a computer device configured to perform methods of embodiments of the present disclosure according to embodiments of the present disclosure.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Embodiments described in the illustrative examples below are not intended to represent all embodiments consistent with the present disclosure. Rather, they are merely embodiments of devices and methods consistent with some aspects of the present disclosure as recited in the appended claims.

With the popularization of computer technology, there are many business scenarios for displaying text, such as web front-end design, advertising packaging, handwriting screens, etc.

In actual display, text can usually have typeface styles, such as Song, Gothic, handwriting, etc. Different typeface styles can adapt to different display scenarios and improve the display effect. Typically, the typeface style can be adjusted for the text to enhance the display effect.

Existing methods can only set the typeface style based on the text's identifier, find the typeface image that represents the text in the corresponding style typeface library for display.

However, for character images where the text identifier cannot be directly determined, such as handwritten characters on a handwriting screen or characters in an image, it is often difficult to adjust the typeface style.

The present disclosure provides a training method for a typeface style conversion network.

In the method, a generative adversarial network can be employed as the structure of the typeface style conversion network, whereby the network can be trained through adversarial learning. The typeface style conversion network may include a generative model and a discriminative model.

Further, samples of character images can be obtained for training the typeface style conversion network.

For ease of explanation, in the present disclosure, in some embodiments, the character itself may not possess a typeface style and can be used to represent a conceptual character. The character image may have a typeface style. Moreover, the characters in the present disclosure are not limited to any language or category, and may include Chinese characters, numerical characters, English characters, and the like.

For example, for the character “Zhuan” without a typeface style, there can be multiple character images, such as “Zhuan” in Song, “Zhuan” in regular script, “Zhuan” in Gothic, and “Zhuan” in handwriting. For the character “a” without a typeface style, there can be multiple character images, including “a” in cursive, “a” in Gothic, and “a” in handwriting.

The embodiments of the present disclosure provide a method for training a typeface style conversion network. Multi-labeled character image samples can be obtained. For example, for the same character image, the character image can be set with multiple sample labels, and different sample labels may include different typeface styles.

For example, for a character image of “Zhuan”, four sample labels can be set, which are the character image of “Zhuan” in Song, the character image of “Zhuan” in regular script, the character image of “Zhuan” in Gothic, and the character image of “Zhuan” in handwriting. In some embodiments, character images of “Zhuan” in different handwritten styles can also be set as sample labels.

When training the typeface style conversion network with such multi-labeled sample, it is usually necessary to distinguish the sample labels of different typeface styles in order to converge.

For example, the multi-labeled sample can be divided into a sample set with Song label style, a sample set with regular script label style, and so on.

Further, for the typeface style conversion network, it is necessary to set a feature input for the target typeface style to be converted, which specifies the typeface style required to be converted to, which enables the learning of different typeface styles separately.

For example, during the training of the typeface style conversion network, a feature representing the “target typeface style” as Song typeface can be input, and training can be performed using a sample set where the label style is the Song typeface style. Subsequently, a feature representing the “target typeface style” as Gothic can be input, and training can be conducted using a sample set where the label style is the Gothic style. And so on.

The trained typeface style conversion network can be used for a specified target typeface style, to convert the input character image to the specified target typeface style.

To facilitate understanding, in an embodiment, the trained typeface style conversion network can be deployed to a handwriting screen device, thereby enabling, in a case of specifying a certain “target typeface style,” the conversion of the character image of the input user's handwritten to the “target typeface style,” such as regular script, thus enhancing the display effect.

For example, user handwritten character images that are more casual or difficult for the audience to recognize can be converted to the regular script, thereby facilitating audience viewing and enhancing the display effect.

Therefore, the trained typeface style conversion network can facilitate the typeface style conversion for character images.

Further, in order to enhance the flexibility of typeface style conversion, without the need to specify a target typeface style, the trained typeface style conversion network is capable of learning multiple typeface styles for the same character. The embodiments of the present disclosure further provide another method for training the typeface style conversion network.

In this method, the trained typeface style conversion network can convert different character images representing the same character to different typeface styles, without the need to specify a target typeface style, thereby enabling more flexible typeface style conversion.

For example, without specifying a target typeface style, the trained typeface style conversion network can convert a character image representing the character “Zhuan” that is obtained by a user copying the Song, to the Song, and further convert a character image representing the character “Zhuan” that is obtained by copying the regular script, to the regular script.

The present disclosure is not limited to the specific typeface styles that the typeface style conversion network can convert. In some embodiments, it may include styles such as Song, Gothic, and Regular scripts, as well as the personal handwritten styles of different users.

For example, for the same typeface, different users may have distinct personal handwritten styles, which may include characteristics such as short horizontals and long verticals, slanting horizontals and verticals, and joined-up writing. The trained typeface style conversion network can learn the personal handwritten styles of various users, and thus be capable of converting different character images representing the same character to different personal handwritten styles.

Correspondingly, the typeface style conversion network trained by this method is not confined to a single typeface style for the same character, but rather exhibits multiple typeface styles, thereby enhancing the display effect and flexibility.

For instance, the trained typeface style conversion network can be deployed on handwriting screen devices, enabling the conversion of character images handwritten by different users to various typeface styles, specifically to different personal handwritten styles, which facilitates the distinction of handwritten character images from different users, enhances the display effect and flexibility, and eliminates the need to specify a target typeface style or to redundantly specify target typeface styles when different typeface styles need to be displayed.

In an embodiment, the character image handwritten by user A can be converted to a personal handwritten style characterized by “short horizontals and long verticals,” and the character image handwritten by user B can be converted to a personal handwritten style with “long horizontals and short verticals.” This process does not require specifying a target typeface style, which allows for flexible display of different typeface styles, facilitating the distinction of handwriting traces from different users, and enhancing the display effect.

Correspondingly, in some embodiments, when obtaining character image samples, different character image samples can be obtained for the same character, respectively including different target character images representing the same character, and different original character images.

The original character images can be determined as sample features, and the target character images can be determined as sample labels.

Furthermore, the same original character image may correspond to only one target character image, and not to multiple target character images of different typeface styles.

In other words, different target character images representing the same character may correspond to different original character images, and may not correspond to the same original character image.

Therefore, in some embodiments, there may be no intersection between different target character images representing the same character and different original character images corresponding to the different target character images.

In some embodiments, a typeface style conversion network can be trained by obtained character image samples to learn the mapping relationships between different original character images and different target character images representing the same character, thereby learning different typeface styles of the same character, which enables the trained typeface style conversion network to convert different character images representing the same character to different typeface styles without specifying a target typeface style, thus allowing more flexible typeface style conversion.

In some embodiments, different target character images may have different typeface styles, such as different personal handwritten styles.

Therefore, the method for training the typeface style conversion network provided by the present disclosure can train a typeface style conversion network with a generative adversarial network structure by utilizing character image samples having different original character images and different target character images, which enables the learning of different typeface styles of the same character (that is, the different typeface styles included in different target character images), allowing the trained typeface style conversion network to convert different character images representing the same character to different typeface styles without specifying a target typeface style, thus facilitating more flexible typeface style conversion.

The following is a detailed explanation of a method for training a typeface style conversion network provided by the present disclosure.

As shown in FIG. 1, FIG. 1 is a flowchart of a for training a typeface style conversion network according to embodiments of the present disclosure.

The present disclosure does not limit the executing subject of the process of the method. In some embodiments, the executing subject can be any computing device. For example, a server for typeface style conversion, or a terminal requiring typeface style conversion.

The method may include the following steps.

In step S101, a preset typeface style conversion network is obtained.

In some embodiments, the preset typeface style conversion network may be a generative adversarial network.

In step S102, a preset character image sample set is obtained.

In some embodiments, the preset character image sample set includes first character image samples, and each of the first character image samples includes a first original character image, sampling information of the first original character image, and a first target character image, where the first original character image and the sampling information of the first original character image serve as sample features, the first target character image serves as a sample label, and the first original character image and the first target character image in the same character image sample representing the same character.

In some embodiments, the preset character image sample set includes multiple first target character images representing the same character, where the multiple first target character images representing the same character respectively correspond to different first original character images.

It should be noted that, for the convenience of distinguishing original character images in different sample sets, the character image sample in the preset character image sample set are referred to as first character image sample. The first original character image belongs to the original character images, and for the convenience of distinguishing original character images in different sample sets, the original character image included in the sample feature of the preset character image sample set is referred to as the first original character image. The first target character image belongs to the target character images, and for the convenience of distinguishing target character images in different sample sets, the target character image included in the sample feature of the preset character image sample set is referred to as the first target character image.

In step S103: the preset typeface style conversion network is trained using the preset character image sample set to obtain a target typeface style conversion network.

In some embodiments, the preset typeface style conversion network may include a preset generative model and a preset discriminative model.

In some embodiments, the preset generative model is configured to generate a conversion result image based on an original character image and sampling information of the original character image, and the preset discriminative model is configured to predict a probability that the conversion result image is a target character image.

In some embodiments, the preset typeface style conversion network may be used to input the target character image and the conversion result image into the preset discriminative model, and the preset discriminative model may be used to predict the probability that the input image is the target character image.

The order of execution for S101 and S102 is not limited in the method. For example, they can be executed in parallel or sequentially.

The aforementioned method, by utilizing character image samples to train the preset typeface style conversion network, enables the trained preset typeface style conversion network to be used for typeface style conversion of character images, thereby facilitating the typeface style conversion of character images.

Moreover, by utilizing character image samples including different original character images and corresponding different target character images to train the Generative Adversarial Network (GAN) structure of the preset typeface style conversion network, it is possible to learn the different typeface styles of the same character (that is, the different typeface styles included in different target character images), enabling the trained target typeface style conversion network to convert different character images representing the same character to different typeface styles, without the need to specify a target typeface style, thereby allowing more flexible typeface style conversion.

Furthermore, it should be noted that since the preset typeface style conversion network trained in this method needs to learn different typeface styles for the same character, in order to improve the convergence speed and reduce the difficulty of convergence, additional sampling information of the original character image can be introduced as a new feature input to the preset typeface style conversion network, thereby increasing the constraints, reducing the learning search range of the network, and facilitating the network's convergence.

The following is a detailed explanation of each step.

1. S101: Obtaining the preset typeface style conversion network.

In some embodiments, the preset typeface style conversion network can be a generative adversarial network, including a preset generative model and a preset discriminative model.

1) Regarding the structure of the preset typeface style conversion network.

The method herein does not limit the specific structure of the preset typeface style conversion network.

In some embodiments, the preset typeface style conversion network may include a preset generative model and a preset discriminative model.

In some embodiments, the preset generative model may be used to generate a conversion result image for an original character image and sampling information of the original character image; the preset typeface style conversion network may be used to input the target character image and the conversion result image into the preset discriminative model; and the preset discriminative model may be used to predict the probability that the input image is the target character image.

In some embodiments, the preset discriminative model may be used to discriminate between the conversion result image and the target character image. In some embodiments, the preset discriminative model may discriminate based on the input conversion result image and the target character image.

In some embodiments, the preset generative model may include an encoder and a decoder. The encoder may be used to extract features for an input original character image and sampling information of the original character image, and the decoder may be used to generate and output a converted predicted typeface style conversion result image based on the features extracted by the encoder.

The embodiments do not limit the specific feature extraction method of the encoder. In some embodiments, features may be extracted comprehensively based on the input original character image and the sampling information of the input original character image. For example, the original character image can be fused with the sampling information, and then features can be extracted. Alternatively, features may be extracted separately for the input original character image and the sampling information, and then the separately extracted features may be integrated. In some embodiments, the encoder may further be used to extract style features for typeface styles.

The embodiments also do not limit the specific image generation method of the decoder. In some embodiments, images may be generated based on the features extracted by the encoder.

In some embodiments, the preset generative model may include an image encoder, a sampling information encoder, and a decoder.

The preset generative model can be configured to: extract image features from an original character image by the image encoder, extract sampling information features from sampling information of the original character image by the sampling information encoder, perform channel concatenation (concat, that is, stacking the image features and sampling information features as different channel features, for example, channel concatenating n channels of image features with m channels of sampling information features to obtain (n+m) channels of concatenated features) on the image features and the sampling information features to obtain a channel concatenation result, and generate a conversion result image by the decoder based on the channel concatenation result.

In some embodiments, the extracted image features and sampling information features can also be subjected to integrated processing, which may specifically include summation, merging, convolution processing, and so on. The present embodiment does not limit the specific methods of integrated processing.

In this embodiment, it should be emphasized that the configuration of the sampling information encoder is a newly added encoder for the generative model in this embodiment, which enables more convenient and accurate extraction of sampling information features, thereby improving the feature extraction effect of the sampling information.

For a detailed explanation of the sampling information, reference can be made to the following text.

In some embodiments, the preset generative model may also include an image encoder, a sampling information encoder, a typeface style encoder, and a decoder.

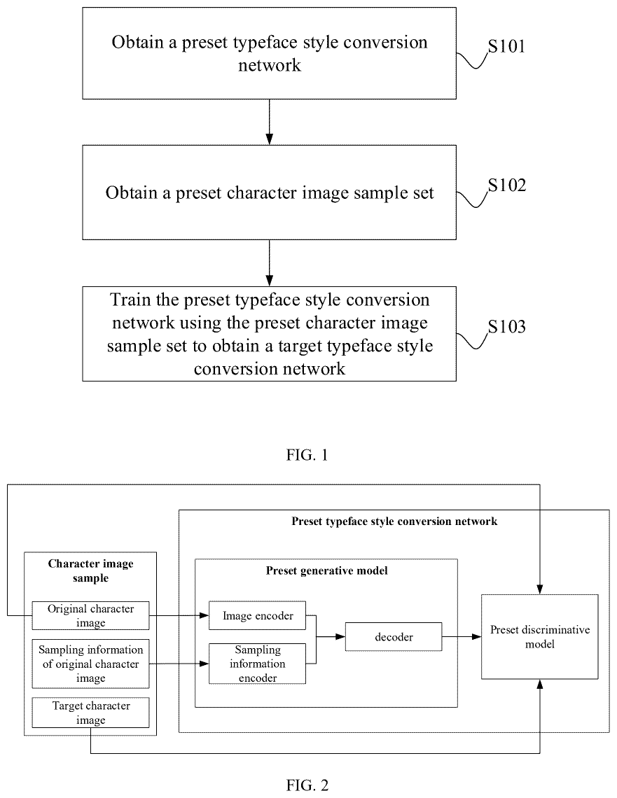

For ease of understanding, as shown in FIG. 2, FIG. 2 is a schematic diagram of a structure of a preset typeface style conversion network according to embodiments of the present disclosure.

The preset typeface style conversion network may include a preset generative model and a preset discriminative model. The preset generative model may include an image encoder, a sampling information encoder, and a decoder.

The original character image and the sampling information of the original character image can be input into the preset generative model of the preset typeface style conversion network, to distinguish two feature inputs, to input the character image into the image encoder, and input the sampling information of the character image into the sampling information encoder, to obtain the image features output by the image encoder, and obtain the sampling information features output by the sampling information encoder.

The image features and sampling information features can be integrated, through stacking or channel concatenation, or other integrating processing methods, and further input into the decoder, to obtain the conversion result image output by the decoder.

The target character image corresponding to the original character image can be input together with the conversion result image into the preset discriminative model for discrimination.

In some embodiments, the original character image can also be input into the preset discriminative model, and the preset discriminative model predicts the probability that the input image (conversion result image) is the target character image based on the original character image.

The discrimination results can be used to train the preset typeface style conversion network until a preset training stop condition are satisfied.

It should be noted that the network structure shown in FIG. 2 is merely for illustrative purposes and does not limit the scope of the present disclosure.

Furthermore, the method herein does not limit the training method and loss function of the preset typeface style conversion network.

In some embodiments, the loss function may include at least one of the following.

1) Category loss is essentially binary cross-entropy loss, constrains the typeface style of the conversion result image and the typeface style of the target character image to be of the same style.

2) Const loss is essentially MSE (Mean Squared Error) loss, calculates the MSE loss between the target character image and the conversion result image, calculates the error between the features obtained after the target character image and the conversion result image are processed by the encoder.

That is, if two characters are similar, the features obtained after the target character image and the generated conversion result image are processed by the encoder should also be similar.

Const loss constrains the target character image and the generated conversion result image to be the same character.

3) L1 loss calculates the mean absolute error loss directly between the generated conversion result image and the target character image.

4) True/Fake loss involves calculating the error between the probability output by the preset discriminative model and the true result of whether the input image is the target character image.

In some embodiments, the true_loss in True/Fake loss may be the cross-entropy loss calculated based on the probability predicted by the preset discriminative model for the input target character image.

The fake_loss may be the cross-entropy loss calculated based on the probability predicted by the preset discriminative model for the input conversion result image.

The loss function can be used to constrain the output of the model as much as possible, reducing the probability that the model learns to produce blurred typefaces.

2) Regarding the obtaining method of the preset typeface style conversion network.

The method does not limit the obtaining method of the preset typeface style conversion network.

In some embodiments, a generative adversarial network can be directly constructed and designated as the preset typeface style conversion network, with its parameters being randomly established.

In some embodiments, it is also possible to obtain a pre-trained typeface style conversion network, which specifically may be a typeface style conversion network trained using character image samples of any form, to obtain a typeface style conversion network with certain typeface style learning capabilities.

Subsequently, based on the structure and parameters of the obtained typeface style conversion network, the structure can be modified to obtain the preset typeface style conversion network, and the parameters of the obtained typeface style conversion network can be inherited and reused as initial parameters for subsequent training.

By utilizing the parameters of the pre-trained typeface style conversion network as initial parameters, as opposed to setting random initial parameters, the training effectiveness and speed of the preset typeface style conversion network can be improved, and the demand for the number of samples can be reduced.

3) The following details the obtaining methods related to the pre-trained network.

In some embodiments, a pre-trained typeface style conversion network can be obtained. For the sake of description, the pre-trained typeface style conversion network is referred to as the “initial typeface style conversion network.”

Subsequently, a structural adjustment can be made to the initial typeface style conversion network, and the corresponding parameters can be inherited as initial parameters to obtain the preset typeface style conversion network before training.

The embodiments are not limited to specific structural adjustments, as long as it can be adjusted to the preset typeface style conversion network.

In some embodiments, the structural adjustment may include adding feature inputs of the sampling information of the original character images, and cascading the feature inputs of the sampling information to the preset generative model, enabling the preset generative model to extract features from the sampling information.

In some embodiments, the structural adjustment may include adding feature inputs of the sampling information of the original character images, and cascading these feature inputs of the sampling information into the encoder of the preset generative model, thereby enabling the feature inputs of sampling information to be encoded by the preset generative model, which allows the preset generative model to extract features based on the sampling information.

In some embodiments, the structural adjustment may include adding feature inputs of sampling information of the original character images, and adding a sampling information encoder. The feature inputs of the sampling information are cascaded to the newly added sampling information encoder, and the output of the sampling information encoder is cascaded to the input of the decoder.

Thus, the feature inputs of the sampling information can be input into the sampling information encoder, and the output of the sampling information encoder can be directly input into the decoder.

Furthermore, the embodiments do not limit the structure and training method of the initial typeface style conversion network.

In some embodiments, the structure of the initial typeface style conversion network may adopt a generative model structure that includes only an image encoder and decoder, or a generative model structure that includes an image encoder, a sampling information encoder, and a decoder, or a generative model structure that includes an image encoder, a typeface style encoder, and a decoder.

In some embodiments, the initial typeface style conversion network may be trained using multi-label character image samples, that is, the same original character image can correspond to samples of different target character images. The initial typeface style conversion network may also be trained using a preset character image sample set as described in S102. Additionally, the initial typeface style conversion network may be trained using a combination of multi-label character image samples and the preset character image sample set.

The pre-trained initial typeface style conversion network can itself learn a certain degree of typeface style conversion capability, thereby providing better network parameters to assist in setting the initial parameters of the preset typeface style conversion network.

Compared to setting random initial parameters, this can enhance the training effectiveness and speed of the preset typeface style conversion network, and can also reduce the demand for the number of samples.

In an embodiment, obtaining the preset typeface style conversion network may include: obtaining a pre-trained initial typeface style conversion network, where the initial typeface style conversion network includes a generative adversarial network, and the generative adversarial network includes an initial generative model and an initial discriminative model, where the initial generative model is configured to generate a second conversion initial image for a second original character image, and the initial discriminative model is configured to predict the probability that the second conversion initial image is a target character image; and converting the initial typeface style conversion network into the preset typeface style conversion network.

In some embodiments, converting the initial typeface style conversion network into the preset typeface style conversion network may include: adding a sampling information encoder to the initial generative model of the initial typeface style conversion network, where the sampling information encoder is configured to encode sampling information of an original character image, cascading an output of the sampling information encoder to an input of a decoder in the initial generative model to obtain the preset generative model, and determining the initial discriminative model as the preset discriminative model.

In some embodiments, the initial generative model may include an image encoder and decoder. When converting the initial typeface style conversion network into the preset typeface style conversion network, the image encoder and decoder of the initial generative model may be determined as the image encoder and decoder of the preset generative model. For example, the structure and parameters of the image encoder and decoder can be directly reused.

In some embodiments, a sampling information encoder can be provided, the feature of sampling information of the original character image can be inputted into the input of the sampling information encoder, and the output of the sampling information encoder can be cascaded to the input of the decoder in the preset generative model.

The embodiments do not limit the training method of the initial typeface style conversion network.

In some embodiments, obtaining the pre-trained initial typeface style conversion network may include: training the initial typeface style conversion network to obtain the pre-trained initial typeface style conversion network; where training the initial typeface style conversion network includes: obtaining an initial character image sample set, where the initial character image sample set includes second character image samples, and each of the second character image samples includes a second original character image and a second target character image, where the second original character image serves as a sample feature, the second target character image serves as a sample label, and the second original character image and the second target character image in the same second character image sample represent the same character; and using the initial character image sample set to train the initial typeface style conversion network.

In some embodiments, handwritten style character images may be used as the second original character images, and character images of a specified typeface style may serve as the second target character images.

In some embodiments, the second original character images can include character images in a handwritten style, and the second target character images can include character images in a printed typeface style.

In some embodiments, the printed typeface style may specifically include the standard typeface style of the printed version, such as Song, Gothic, Regular script, etc.

In some embodiments, the training method for the initial typeface style conversion network may include: obtaining an initial character image samples set, where the features of the character image samples in the initial character image sample set include the second original character images, and the labels for the character image samples include the second target character images, where the second original character image and the second target character image within the same character image sample represent the same character; and utilizing the initial character image sample set to train the initial typeface style conversion network.

The specific samples in the initial character image sample set are not limited.

In some embodiments, there may be different second target character images corresponding to different second original character images, or there may be the same second original character image corresponding to different second target character images.

In some embodiments, the character image samples in the initial character image sample set are referred to as second character image samples, to distinguish from the first character image samples. The structure of the second character image samples may differ from the structure of the first character image samples. The sample features of the second character image samples include the original character image, while the sample features of the first character image samples include the original character image and the sampling information of the original character image.

In some embodiments, the second original character images are used to distinguish from the sample features (the first original character images) in the preset character image sample set. The second original character images are the original character images, and the original character images included in the sample features of the initial character image sample set are referred to as the second original character images. In some embodiments, the second original character images may have the same form as the first original character images, and their content may be the same or different. The second target character image is interpreted in the same way.

2. S102: Obtaining the preset character image sample set.

In some embodiments, the preset character image sample set includes first character image samples, and each of the first character image samples includes a first original character image, sampling information of the first original character image, and a first target character image, where the first original character image and the sampling information of the first original character image serve as sample features, the first target character image serves as a sample label, and the first original character image and the first target character image in the same character image sample representing the same character.

In some embodiments, the preset character image sample set includes multiple first target character images representing the same character, and the multiple first target character images correspond to different first original character images.

1) Regarding sampling information.

The method process does not limit the specific sampling information.

In some embodiments, the sampling information includes position information of character sampling points and/or position information of character trajectories.

In some embodiments, the sampling information includes the position information of the character sampling points, and the sampling information further includes sequence information of the character sampling points; and/or the sampling information includes the position information of the character trajectories, and the sampling information further includes sequence information of the character trajectories.

In some embodiments, the position information of the character sampling points can represent the position information of the points sampled in the character image. The sequence information of the character sampling points can represent the sampling order of different points sampled in the character image.

The embodiments do not limit the specific character sampling method.

For ease of understanding, in an embodiment, a fixed number of sampling points can be sampled for each line in the character image, so that the distance between sampling points can be determined based on the position information of the sampling points, and thus the length and inclination of the line can be determined. The sequence information of the sampling points can specifically be in an order from top to bottom and from left to right.

The embodiments do not limit the form of character trajectories. The trajectories within the character can specifically be represented by points, i.e., trajectory points, or by lines within the character, i.e., trajectory lines.

In some embodiments, the position information of the character trajectories can include the position information of trajectory points and/or trajectory lines. The sequence information of the character trajectories can include the writing order of each trajectory in the character image, which can specifically be used to represent the order of strokes.

For ease of understanding, in an embodiment, sampling can be performed on the writing order of each trajectory during the writing process for the character image. Specifically, a set of trajectory points with sequential order or a set of trajectory lines with sequential order can be obtained.

The embodiments do not limit the specific means of obtaining sampling information.

In some embodiments, an obtaining method for the sampling information includes: sampling writing trajectories of the first original character image to obtain the sampling information.

In some embodiments, sampling the writing trajectories of the first original character image to obtain the sampling information includes: sampling the writing trajectories of the first original character image on a touch screen to obtain trajectories with a temporal sequence relationship; and determining the trajectories with the temporal sequence relationship as the sampling information.

In some embodiments, the touch screen may specifically be a handwriting screen, which allows for sampling based on the user's writing trajectories on the handwriting screen to obtain trajectories with a temporal sequence. For example, the touch screen includes an infrared touch component or a capacitive touch component. The touch component captures the touch trajectory points during the user's handwriting, and the touch component sends the touch trajectory points to the SOC (System on Chip). The SOC stores the received touch trajectory points as sampling information and generates text (i.e., the first original character image) based on the received touch trajectory points. Alternatively, the SOC may perform sparse sampling on the received touch trajectory points and save the information of the sparsely sampled trajectory points as sampling information. The trajectory points can be with a temporal sequence, or it can be the sequence of strokes in the writing.

In some embodiments, an obtaining method of the sampling information includes: sampling the first original character image to obtain the sampling information.

2) Regarding an obtaining method for the sample set.

The method does not limit the specific means of obtaining the preset character image sample set, as long as the different first target character images representing the same character correspond to different first original character images.

In some embodiments, multiple character images representing the same character can be obtained. A portion of the character images can be determined as N different first target character images, and the remaining character images can be divided into N subsets without intersection respectively corresponding to the N first target character images.

Thus, each character image can be obtained from the subset corresponding to the first target character image as a first original character image, and the sampling information of the first original character image can be obtained, to form a first character image sample to be added to the preset character image set.

In an embodiment, to facilitate the typeface style conversion network to converge more rapidly during the training process, when the character image sample in the preset character image sample set is obtained, based on the first target character image, a character image that is close to or similar to the first target character image can be determined as the first original character image. Consequently, by learning the typeface styles that are close or similar between the first original character image and the first target character image, the trained preset typeface style conversion network can convert an input character image to a typeface style that is close or similar.

For example, the character image that are close to or similar to the first target character image can be determined by calculating image similarity. Character images with an image similarity to the first target character image greater than a preset similarity threshold can be considered as character images being close to or similar to the first target character image.

In some embodiments, different first target character images representing the same character can have different typeface styles. The target typeface style conversion network is configured to: for inputs of different character images representing the same character, output conversion result character images with different typeface styles.

In some embodiments, the preset generative model in the target typeface style conversion network can be configured to: for inputs of character images, output conversion result character images with a similar typeface style.

In some embodiments, the preset generative model in the target typeface style conversion network may have the following capabilities: for inputs of different character images representing the same character, outputting conversion result character images with similar typeface styles. The preset generative model can be used to output conversion result character images with similar typeface styles for inputs of different character images representing the same character.

The output conversion result character images are allowed to have differing typeface styles.

In some embodiments, different first target character images representing the same character can have different typeface styles; and the preset generative model in the target typeface style conversion network may have the following capabilities: for inputs of different character images representing the same character, outputting conversion result character images with different typeface styles.

As illustrative examples, the present disclosure provides the following sample obtaining methods.

In some embodiments, the obtaining method for the first character image sample in a preset character image sample set may include: determining different character images that represent the same character and have different typeface styles as first target character images; and based on the first target character images, respectively obtaining sample features to obtain the first character image samples.

For example, for each first target character image, different first original character images are generated or obtained, and sampling information is determined for the obtained first original character images, thereby obtaining the first character image samples, which are then added to the preset character image sample set.

The embodiments do not limit the obtaining method for sample features of the first target character image.

In some embodiments, obtaining sample features according to the determined first target character images may include at least one of the following:
1) for any one of the multiple first target character images, obtaining at least one first original character image through image enhancement processing, and determining sampling information for the at least one first original character image;
2) for any one of the multiple first target character images, determining at least one character image each with an image similarity to the first target character image higher than a preset similarity as at least one first original character image, and determining sampling information for the at least one first original character image; or
3) for any one of the multiple first target character images, obtaining at least one character image of copied writing, determining the at least one character image as at least one first original character image, and determining sampling information for the at least one first original character image.

For ease of understanding, in an embodiment, training and learning can be conducted for personal handwritten styles.

In an embodiment, to facilitate the typeface style conversion network to converge more quickly during the training process, when character image samples in the preset character image sample set are obtained, based on the first target character image, character images that are close to or similar to the first target character image can be determined as the first original character images. Thus, by learning the personal handwritten style that is close or similar between the first original character image and the first target character image, the trained preset typeface style conversion network can convert to a close or similar personal handwritten style for the input character images.

In some embodiments, different first target character images representing the same character may have different handwritten styles. The preset generative model in the target typeface style conversion network can be configured to: for inputs of different character image representing the same character, output conversion result character images with different handwritten styles.

In some embodiments, the preset generative model in the target typeface style conversion network can be configured to: output conversion result character images with similar personal handwritten styles for inputs of character images.

In some embodiments, the preset generative model in the target typeface style conversion network may have the following functions: for different character image inputs representing the same character, output conversion result character images with similar personal handwritten styles. The preset generative model can be configured to: output conversion result character images with similar personal handwritten styles for different character image inputs representing the same character.

The output conversion result character images are allowed to have different personal handwritten styles.

In some embodiments, different first target character images representing the same character can have different handwritten styles; the preset generative model in the target typeface style conversion network may have the following functions: for inputs of different character images representing the same character, output conversion result character images with different handwritten styles.

Since the learning involves multiple different personal handwritten styles, in the actual process of collecting character images to generate samples, an individual can repeatedly handwrite the same character multiple times, thereby conveniently collecting character images with the same or similar personal handwritten styles for generating samples.

In an embodiment, each data collector may write each common Chinese character multiple times. Thus, for each data collector, multiple character images can be obtained for each common Chinese character. These character images can serve as training data, with labels being the individual Chinese characters transcribed by each data collector, such as the characters formally transcribed individually by each data collector.

In some embodiments, a single character image can be selected as the target character image from the multiple character images of each Chinese character written by each data collector, with the remaining character images serving as the first original character images.

For ease of understanding, for example, a data collector may formally transcribe the character “Zhuan” in Song typeface to obtain a “Zhuan” character image with a personal handwritten style, serving as the first target character image.

Subsequently, the same data collector may handwrite the character “Zhuan” multiple times to obtain multiple “Zhuan” character images, which serve as various first original character images for generating samples, thereby obtaining first original character images and the first target character image with the same or similar personal handwritten style.

As illustrative examples, the present disclosure provides the following sample obtaining methods.

In some embodiments, the obtaining method for character image samples in the preset character image sample set may include: determining different character images that represent the same character and have different personal handwritten styles as the first target character images; obtaining sample features based on the first target character images to obtain first character image samples. For example, for the first target character images, different first original character images are respectively generated or obtained, and sampling information is determined for the obtained first original character images, thereby obtaining the first character image samples. The obtained first character image samples are added to the preset character image sample set.

The embodiments do not limit to the obtaining manner for sample features of the first target character images.

In some embodiments, obtaining the sample features based on the determined first target character images may include at least one of the following.

1) For any one of the multiple first target character images, obtaining at least one first original character image through image enhancement processing, and determining sampling information for the at least one first original character image.

2) For any one of the multiple first target character images, determining at least one character image each with an image similarity to the first target character image higher than a preset similarity as at least one first original character image, and determining sampling information for the at least one first original character image.

3) For any one of the multiple first target character images, obtaining at least one character image of copied writing, determining the at least one character image as at least one first original character image, and determining sampling information for the at least one first original character image.

4) For any one of the multiple first target character images, determining at least one character image obtained by handwriting a character represented by the first target character image in the same handwritten style as at least one first original character image, and determining sampling information for the at least one first original character image.

In some embodiments, an obtaining method for character image samples in the preset character image sample set includes: obtaining different character images handwritten by different individuals for the same character, where the different individuals have different handwritten styles, and for the same character, the number of character images obtained by handwriting the same character by the same individual based on the same handwritten style is greater than or equal to 2; and determining any one of character images handwritten by the same individual as the first target character image, and determining other character images as first original character images, and determining sampling information for the first original character images, to obtain character image samples.

In S103, the preset typeface style conversion network is trained using the preset character image sample set to obtain a target typeface style conversion network.

The method process does not limit specific training methods. In some embodiments, adversarial learning can be employed. The method process also does not limit the specific structure and specific discrimination method of the preset discriminative model.

The aforementioned method, by utilizing character image samples to train the preset typeface style conversion network, enables the trained preset typeface style conversion network to be used for typeface style conversion for character images, thereby facilitating the typeface style conversion of character images.

Furthermore, by utilizing the Generative Adversarial Network structure to train the preset typeface style conversion network with character image samples that include different target character images representing the same character, as well as different character image samples including various original character images, it is possible to learn the different typeface styles of the same character (that is, the different typeface styles included in the different target character images). This enables the trained target typeface style conversion network to convert different character images representing the same character to different typeface styles without the need to specify a target typeface style, thereby allowing more flexible typeface style conversion.

Additionally, it should be noted that since the preset typeface style conversion network trained in this method needs to learn different typeface styles of the same character, in order to increase the convergence speed and reduce the difficulty of convergence, sampling information of the original character images can be added as a new feature input to the preset typeface style conversion network, which can increase the constraint conditions, reduce the learning search range of the network, and is conducive to the network's convergence.

The aforementioned method process can also be improved by adding a sampling information encoder, which enhances the structure of the typeface style conversion network, resulting in a new network structure.

Based on the target typeface style conversion network trained using the above method embodiments, the embodiments of the disclosure further provide a typeface style conversion method.

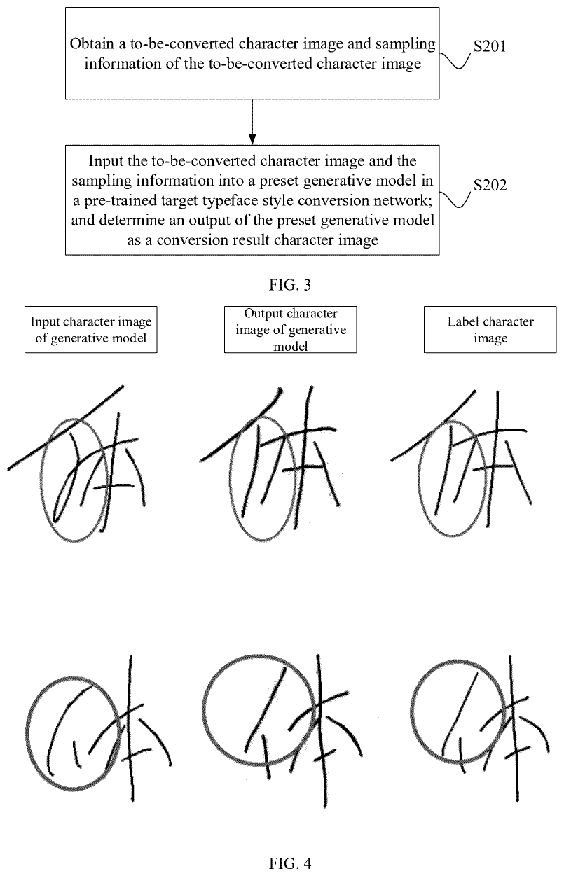

As shown in FIG. 3, FIG. 3 is a flowchart of a typeface style conversion method according to embodiments of the present disclosure.

The embodiments of the disclosure do not limit the executing subject of this method. In some embodiments, the executing subject can be any computing device. For example, a server for typeface style conversion, or a terminal that requires typeface style conversion.

The method may include the following steps.

In step S201, a to-be-converted character image and sampling information of the to-be-converted character image are obtained.

In step S202, the to-be-converted character image and the sampling information are inputted into a preset generative model in a pre-trained target typeface style conversion network; and an output of the preset generative model is determined as a conversion result character image.

In some embodiments, the target typeface style conversion network may be trained by any one of the aforementioned method embodiments.

The method does not limit the specific obtaining method for sampling information.

In some embodiments, the obtaining method for the sampling information of the to-be-converted character image may include: sampling writing trajectories of the to-be-converted character image to obtain the sampling information.

In some embodiments, sampling the writing trajectories of the to-be-converted character image to obtain the sampling information includes: sampling the writing trajectories of the to-be-converted character image on a touch screen to obtain trajectories with a temporal sequence relationship; and determining the trajectories with the temporal sequence relationship as the sampling information.

In some embodiments, an obtaining method for the sampling information includes: sampling the to-be-converted character image to obtain the sampling information.

For specific related explanations, reference can be made to the explanations of the method embodiments described above.

To facilitate understanding, the present disclosure further provides an application embodiment.

When writing Chinese characters on the screen, it is desirable to beautify each character to a certain extent, such as converting one's own typeface into a calligraphic typeface, and further hoping that the converted calligraphy retains the style of the original typeface to a certain degree.

The present solution aims to retain the personal handwritten style to a certain extent while the original handwritten typeface approaches a certain calligraphic typeface (such as regular script).

Therefore, the present solution has made adjustments in the label settings, where the labels are no longer standard calligraphic typeface images but are handwritten character images obtained by data collectors transcribing calligraphic typefaces, thereby ensuring that differences exist in each character across various labels.

Simultaneously, to address the issue of training difficulties encountered by generative adversarial networks in typeface style conversion, the present solution introduces trajectory points as an auxiliary training branch, facilitating an easier convergence during the network training process.

The specific application scenarios of this solution may include: smart blackboards, conference large screens, and other office, meeting, and exhibition venues.

The objective of the solutions is to meet the needs of educational, office meeting, or exhibition occasions, where Chinese characters are generally written on a handwriting screen, with the expectation to convert the characters into typefaces with calligraphic style, while also desiring to avoid generating completely identical typefaces from different individuals' handwritings, that is, to maintain distinctiveness. Based on this requirement, it necessitates the use of generative adversarial networks for the generation of Chinese characters.

Below is a brief introduction to the solutions.

The embodiment proposes a method for the style conversion of handwritten Chinese characters, used for the generation of characters. In the context of a handwriting screen, it aims to convert temporarily handwritten Chinese characters into typefaces with calligraphic style, such as into the regular script of Ouyang Xun, while also retaining to some extent the personal handwritten style of the original typeface.

The solutions of the embodiments can integrate trajectory points and character images to obtain typefaces that possess both the existing calligraphic typeface style and personal handwritten style through generative adversarial networks.

In the solutions of the embodiments, both the handwriting trajectory points and character images are used as inputs for the generative adversarial network, rather than purely character images, while the labels for the model are the calligraphic typefaces transcribed by each data collector.

Through such training, the output of the generative model in the generative adversarial network can possess both personal handwritten style and calligraphic typeface style, rather than outputting a singular calligraphic typeface.

The solutions of the embodiments propose a style conversion method for a generative adversarial network based on handwritten Chinese character trajectory points and character images.

The foundational network of the method can be the zi2zi network frequently used in typeface style conversion networks, and the input of the network is the original character image. The method augments an auxiliary branch on this basis, inputting trajectory points of the original character image.

The label corresponding to each original character image is the calligraphy typeface transcribe by the data collector, thereby enabling the typeface output by the generative model in the generative adversarial network to possess both personal writing style and calligraphy typeface style.

As shown in FIG. 4, FIG. 4 is a schematic diagram of a principle of typeface style conversion according to embodiments of the present disclosure.

The first character in each row is the character image input into the generative adversarial network, the second character is the character image generated by the model, which specifically can be the character image output by the generative model in the generative adversarial network, and the third character is the label (that is, the character image obtained from a user copying calligraphy typefaces).

The two lines respectively represent the character “Ti” written by different individuals. It can be seen from FIG. 4 that after learning, the typefaces generated by the model are able to align with their respective labels, thus converting to a similar personal handwritten style.

Specifically, the different personal handwritten styles can be observed through the areas encircled by circles.

The conversion of two different “Ti” character images in FIG. 4 can be regarded as an example of the conversion result in the specific use of the generative model for the target typeface style conversion network in the aforementioned method.

The following is a detailed explanation of the present solution.

The concept of the present solution is that, during the data collection phase, each data collector writes each common Chinese character multiple times. Thus, for each data collector, multiple character images can be obtained for each character, which can be used to generate training data. The labels for the training data can be the character images of each Chinese character transcribe by each data collector.

In some embodiments, one of the multiple images of each character written by each data collector can be selected as the label, with the remaining images serving as the sample features corresponding to that label.

Currently, some publicly available datasets can be obtained, but these datasets are not entirely suitable for the present solution.

The reason is that such publicly available data generally consists of each person writing each Chinese character only once, which results in the inability to select one image as the label according to a predetermined approach, with the remainder serving as training data.

In order to utilize these data and based on their characteristics, for each Chinese character, it is possible to find the regular script typeface of the character to serve as the label. It is hoped that by initially learning from handwritten characters to regular script, a version of the model can be pre-trained to enable it to obtain the basic learning of typeface strokes.

The pre-training model can employ the zi2zi network, with an input image size of 256*256, a batch size set to 32, training epochs set to 200, an initial learning rate of 0.002, and a learning rate schedule that reduces the rate to half of its previous value every 10 epochs, utilizing V100 GPU hardware.

The learning rate is a parameter required during model training. At the initial stage of training, since the model parameters are largely randomly initialized and far from the optimal parameters, a larger learning rate is generally employed to find the best possible solution.

When retraining with a pre-trained model, since the parameters of the pre-trained model have already been optimized compared to the initial model, it is necessary to reduce the learning rate to avoid excessive perturbations caused by a large learning rate. Therefore, in the solutions, the learning rate is set to half of its original value for further training.

The extent to which the learning rate is reduced here is not limited; it can be 0.5 times, or 0.3 times, among others.

A model that has undergone pre-training can possess the capability to learn the style of typefaces.

The generator part of the original zi2zi network is an encoder-decoder structure, with the input being character images of handwritten text. This structure is effective for the conversion of ordinary handwritten text to a certain type of typeface, such as regular script.

However, for the purpose proposed by the solutions to possess both calligraphic typeface styles and personal handwritten styles, the learning difficulty of the network increases, as the personal handwritten styles for the same character are also distinct (different collectors transcribe the same character differently).

To enhance the network's constraint capability, reduce its learning space, and facilitate easier convergence, the solution additionally incorporates an encoder into the generator part of the original zi2zi network. This encoder processes the trajectory points of a character image, with the input being the trajectory points of the original character image and the output being a feature map. Channel concatenation is then performed on this feature map and the feature map generated by the original encoder, enabling the network to simultaneously obtain the trajectory information of the handwritten text before feeding it into the subsequent decoder.

The settings for the network structure's loss function and parameters can remain consistent with the original zi2zi.

After obtaining the pre-trained model, the enhanced model is trained using previously collected training data. During training, the various parameters set can remain the same as during pre-training, except that the initial learning rate is reduced to half of the pre-trained model's initial learning rate.

The trained model is capable of converting character images written by different individuals to the similar or identical personal handwritten styles of data collectors, to obtain character images of the converted styles under the individual's handwritings.

In other words, as each data collector provides labels in a distinct personal handwritten style, the model has the capability to convert different handwritten characters to various personal handwritten styles.

The improvements of this solution primarily reside in the novel network formed by modifying the zi2zi network structure; it introduces the concept of using typeface trajectory points as auxiliary input information in typeface style conversion; and it is capable of achieving handwritten style conversion that encompasses both calligraphic typeface style and personal handwritten style through model training.

Corresponding to the aforementioned method embodiment, the embodiments of the disclosure further provide embodiments of an apparatus.

As shown in FIG. 5, FIG. 5 is a schematic diagram of a structure of an apparatus for training a typeface style conversion network according to embodiments of the present disclosure.

The apparatus may include the following units:
a network obtaining unit 301, configured to obtain a preset typeface style conversion network, where the preset typeface style conversion network includes a generative adversarial network;
a sample obtaining unit 302, configured to obtain a preset character image sample set, where the features of the character image samples in the preset character image sample set include the first original character image and the sampling information of the first original character image, and the label of the character image sample includes the target character image. The first original character image and the target character image in the same character image sample represent the same character.

In some embodiments, the preset character image sample set may include multiple first target character images representing the same character, where different first target character images representing the same character may correspond to different first original character images.

a training unit 303, configured to train the preset typeface style conversion network using the preset character image sample set to obtain a target typeface style conversion network.

In some embodiments, the preset typeface style conversion network includes a preset generative model and a preset discriminative model.

The preset generative model is configured to generate a conversion result image based on an original character image and sampling information of the original character image, and the preset discriminative model is configured to predict a probability that the conversion result image is a target character image.

In some embodiments, the sampling information includes position information of character sampling points and/or position information of character trajectories.

In some embodiments, the sampling information includes the position information of the character sampling points, and the sampling information further includes sequence information of the character sampling points; and/or the sampling information includes the position information of the character trajectories, and the sampling information further includes sequence information of the character trajectories.

In some embodiments, an obtaining method for the sampling information includes: sampling writing trajectories of the first original character image to obtain the sampling information.

In some embodiments, sampling the writing trajectories of the first original character image to obtain the sampling information includes: sampling the writing trajectories of the first original character image on a touch screen to obtain trajectories with a temporal sequence relationship; and determining the trajectories with the temporal sequence relationship as the sampling information.

In some embodiments, an obtaining method of the sampling information includes: sampling the first original character image to obtain the sampling information.

In some embodiments, the preset generative model includes an image encoder, a sampling information encoder, and a decoder, and the preset generative model is configured to: extract image features from an original character image by the image encoder; extract sampling information features from sampling information of the original character image by the sampling information encoder; perform channel concatenation on the image features and the sampling information features to obtain a channel concatenation result; and generate a conversion result image by the decoder based on the channel concatenation result.

In some embodiments, the network obtaining unit 301 is used for: obtaining a pre-trained initial typeface style conversion network, where the initial typeface style conversion network includes a generative adversarial network, and the generative adversarial network includes an initial generative model and an initial discriminative model, where the initial generative model is configured to generate a second conversion initial image for a second original character image, and the initial discriminative model is configured to predict the probability that the second conversion initial image is a target character image; and converting the initial typeface style conversion network into the preset typeface style conversion network including: adding a sampling information encoder to the initial generative model of the initial typeface style conversion network, where the sampling information encoder is configured to encode sampling information of an original character image, cascading an output of the sampling information encoder to an input of a decoder in the initial generative model to obtain the preset generative model, and determining the initial discriminative model as the preset discriminative model.

In some embodiments, the network obtaining unit 301 is used for: training the initial typeface style conversion network to obtain the pre-trained initial typeface style conversion network. the network obtaining unit 301 is used for: obtaining an initial character image sample set, where the initial character image sample set includes second character image samples, and each of the second character image samples includes a second original character image and a second target character image, where the second original character image serves as a sample feature, the second target character image serves as a sample label, and the second original character image and the second target character image in the same second character image sample represent the same character; and using the initial character image sample set to train the initial typeface style conversion network.

In some embodiments, the second original character image includes a character image in handwritten style, and the second target character image includes a character image in printed typeface style.

In some embodiments, the multiple first target character images representing the same character have different typeface styles; the preset generative model in the target typeface style conversion network is configured to: for inputs of different character images representing the same character, output conversion result character images with different typeface styles.

In some embodiments, an obtaining method for the character image samples in the preset character image sample set includes: determining different character images representing the same character and having different typeface styles as multiple first target character images; and according to the multiple first target character images, respectively obtaining sample features to obtain the first character image samples.

In some embodiments, according to the multiple first target character images, respectively obtaining the sample features includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image; or
for any one of the multiple first target character images, obtaining at least one character image of copied writing, determining the at least one character image as at least one first original character image, and determining sampling information for the at least one first original character image.

In some embodiments, the multiple first target character images representing the same character have different handwritten styles; the preset generative model in the target typeface style conversion network is configured to: for inputs of different character images representing the same character, output conversion result character images with different handwritten styles.

In some embodiments, an obtaining method for character image samples in the preset character image sample set includes: determining different character images representing the same character and having different handwritten styles as multiple first target character images, and obtaining sample features respectively according to the multiple first target character images, to obtain the first character image samples.

In some embodiments, obtaining the sample features respectively according to the first target character images includes at least one of the following:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a preset similarity as at least one first original character image, and determining sampling information for the at least one first original character image;
for any one of the multiple first target character images, obtaining at least one character image of copied writing, determining the at least one character image as at least one first original character image, and determining sampling information for the at least one first original character image; or
for any one of the multiple first target character images, determining at least one character image obtained by handwriting a character represented by the first target character image in the same handwritten style as at least one first original character image, and determining sampling information for the at least one first original character image.

In some embodiments, an obtaining method for character image samples in the preset character image sample set includes:
obtaining different character images handwritten by different individuals for the same character,
where the different individuals have different handwritten styles, and for the same character, the number of character images obtained by handwriting the same character by the same individual based on the same handwritten style is greater than or equal to 2; and
determining any one of character images handwritten by the same individual as the first target character image, and determining other character images as first original character images, and determining sampling information for the first original character images, to obtain character image samples.

For a detailed explanation, reference can be made to the method embodiments described above.

As shown in FIG. 6, FIG. 6 is a schematic diagram of a structure of an apparatus for training a typeface style conversion network according to embodiments of the present disclosure.

The apparatus may include the following units:
an obtaining unit 401, for obtaining a to-be-converted character image and sampling information of the to-be-converted character image.
a converting unit 402, for inputting the to-be-converted character image and the sampling information into a preset generative model in a pre-trained target typeface style conversion network; and determining an output of the preset generative model as a conversion result character image; the target typeface style conversion network is obtained through training by the aforementioned apparatus embodiments.

In some embodiments, the target typeface style conversion network may be obtained through training by any one of the aforementioned method embodiments or apparatus embodiments.

The method does not limit the specific method for obtaining sampling information.

In some embodiments, an obtaining method for the sampling information includes: sampling writing trajectories of the to-be-converted character image to obtain the sampling information.

In some embodiments, sampling the writing trajectories of the to-be-converted character image to obtain the sampling information includes: sampling the writing trajectories of the to-be-converted character image on a touch screen to obtain trajectories with a temporal sequence relationship; and determining the trajectories with the temporal sequence relationship as the sampling information.

In some embodiments, an obtaining method for the sampling information includes: sampling the to-be-converted character image to obtain the sampling information.

For a detailed explanation, reference can be made to the method embodiments described above.

The embodiments of the present disclosure further provide a computer device including a memory, a processor, and a computer program that is stored in the memory and runnable on the processor, where the processor when executing the program, implements any one of the above method embodiments.

The embodiments of the present disclosure further provide an electronic device including: one or more processors, and one or more memories in communication with the one or more processor. The one or more memories store instructions that can be executed by the one or more processors, and the one or more processors when executing the instructions implements the method according to any one of the above method embodiments.

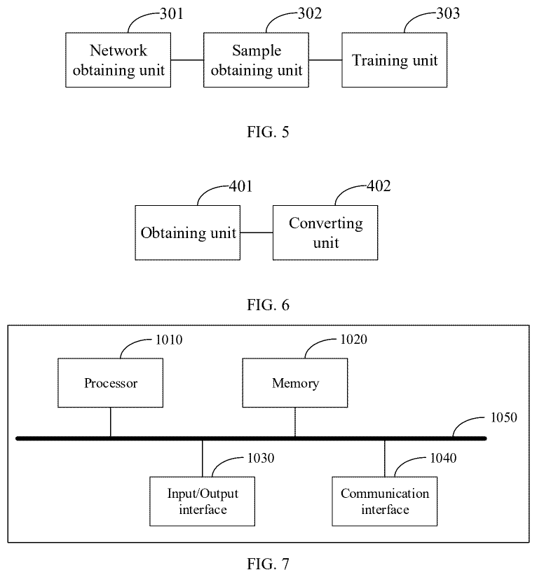

FIG. 7 is a schematic diagram of a hardware structure of a computer device configured to perform methods of the embodiments of the present disclosure according to the embodiments of the present disclosure. The device may include: a processor 1010, a memory 1020, an input/output interface 1030, a communication interface 1040, and a bus 1050. The processor 1010, memory 1020, input/output interface 1030, and communication interface 1040 are connected to each other through the bus 1050 for communication within the device.

Processor 1010 can be implemented using a general CPU (Central Processing Unit), microprocessor, Application Specific Integrated Circuit (ASIC), or one or more integrated circuits to execute related programs to implement the technical solution provided in the embodiments of the present disclosure.

Memory 1020 can be implemented in the form of ROM (Read Only Memory), RAM (Random Access Memory), static storage devices, dynamic storage devices, etc. Memory 1020 can store operating systems and other application programs. When implementing the technical solution provided in the embodiments of the present disclosure through software or hardware, the relevant program code is stored in memory 1020 and called and executed by processor 1010.

Input/output interface 1030 is used to connect input/output modules for information input and output. The input/output/module can be configured as a component in the device (not shown in the drawings), or can be externally connected to the device to provide corresponding functions. The input devices can include keyboards, mice, touch screens, microphones, various sensors, etc., while the output devices can include displays, speakers, vibrators, indicator lights, etc.

Communication interface 1040 is used to connect communication modules (not shown in the drawings) to achieve communication interaction between the device and other devices. The communication module can be achieved through wired methods (such as USB, Ethernet cables, etc.), as well as wireless methods (such as mobile networks, WIFI, Bluetooth, etc.).

Bus 1050 includes a path for transmitting information between various components of the device, such as processor 1010, memory 1020, input/output interface 1030, and communication interface 1040.

It should be noted that although the above device only illustrates processor 1010, memory 1020, input/output interface 1030, communication interface 1040, and bus 1050, in the specific implementation process, the device may further include other components necessary for normal operation. In addition, those skilled in the art can understand that the above-mentioned devices may only include the components necessary to implement the embodiments of the present disclosure, without necessarily including all the components shown in the drawings.

The embodiments of the present disclosure further provides a computer-readable storage medium on which a computer program is stored, and any one of the above method embodiments are implemented when the program is executed by a processor.

The embodiments of the present disclosure further provides a computer-readable storage medium storing a computer program, when the computer program is executed by a processor, any one of the above method embodiments is implemented.

Computer readable media include permanent and non-permanent, removable and non-removable media that can be implemented by any method or technology to store information. Information may be computer readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read only memory (CDROM), digital versatile disc (DVD) or other optical storage, magnetic cartridge tape, magnetic tape magnetic disk storage, other magnetic storage device or any other non-transport medium that can be used to store information that can be accessed by a computing device. As defined herein, computer readable media does not include transitory computer readable media, such as modulated data signals and carriers.

Through the description of the above embodiments, those skilled in the art can clearly understand that the methods of the above embodiments can be implemented by means of software plus a necessary general-purpose hardware platform. Based on this understanding, the technical solutions of the embodiments of the present disclosure can essentially or in other words, contribute in the form of software products, which can be stored in storage media such as ROM/RAM, disks, CDs, etc., including several instructions to enable a computer device (which can be a personal computer, server, or network device, etc.) to execute the methods described in various embodiments or certain parts of the embodiments of the present disclosure.

The systems, apparatuses, modules, or units elucidated in the above embodiments can be implemented specifically by a computer chip or entity, or by a product with certain functions. A typical implementation device is a computer, which can take the form of a personal computer, laptop, cellular phone, camera phone, smart phone, personal digital assistant, media player, navigation device, email sending and receiving device, game console, tablet computer, wearable device, or any combination of these devices.

The various embodiments in the present disclosure are described in a progressive manner, and the same or similar parts between the various embodiments may be referred to each other, and each embodiment focuses on the differences from other embodiments. In particular, for the apparatus embodiments, since it is basically similar to the method embodiment, the description is relatively simple, and for related parts, please refer to the partial description of the method embodiment. The apparatus embodiments described above are only illustrative, and the modules described as separate components may or may not be physically separate. When implementing the embodiments of the present disclosure, the functions of each module can be implemented in the same or multiple software and/or hardware. Part or all of the modules may be selected according to actual requirements to implement the objectives of the solutions in the examples. A person skilled in the art can understand and implement without creative work.

The above are only specific implementations of the embodiments of the present disclosure. It should be pointed out that for ordinary technical personnel in the art, several improvements and embellishments can be made without departing from the principles of the embodiments of the present disclosure. These improvements and embellishments should also be considered as protection of the embodiments of the present disclosure.

In the present disclosure, the terms “first” and “second” are only for descriptive purposes, and cannot be understood as indicating or implying relative importance. The term “multiple” means two or more, unless otherwise clearly defined.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A method, comprising:
obtaining a typeface style conversion network, wherein the typeface style conversion network comprises a first generative adversarial network;
obtaining a character image sample set, wherein the character image sample set comprises first character image samples, and each of the first character image samples comprises a first original character image, sampling information of the first original character image, and a first target character image, wherein the first original character image and the sampling information of the first original character image serve as sample features, the first target character image serves as a sample label, and the first original character image and the first target character image in the same character image sample representing the same character; and
training the typeface style conversion network using the character image sample set to obtain a target typeface style conversion network.

2. The method according to claim 1, wherein the character image sample set comprises multiple first target character images representing the same character, wherein the multiple first target character images representing the same character respectively correspond to different first original character images.

3. The method according to claim 1, wherein the typeface style conversion network comprises a generative model and a discriminative model, wherein the generative model is configured to generate a conversion result image based on an original character image and sampling information of the original character image, and the discriminative model is configured to predict a probability that the conversion result image is a target character image.

4. (canceled)

5. The method according to claim 1, wherein
the sampling information comprises position information of character sampling points, and sequence information of the character sampling points; and/or
the sampling information comprises position information of character trajectories, and sequence information of the character trajectories.

6. The method according to claim 1, further comprising:
sampling writing trajectories of the first original character image to obtain the sampling information.

7. The method according to claim 6, wherein sampling the writing trajectories of the first original character image to obtain the sampling information comprises:
sampling the writing trajectories of the first original character image on a touch screen to obtain trajectories with a temporal sequence relationship; and
determining the trajectories with the temporal sequence relationship as the sampling information.

8. The method according to claim 1, further comprising:
sampling the first original character image to obtain the sampling information.

9. The method according to claim 3, wherein the generative model comprises an image encoder, a sampling information encoder, and a decoder, and the generative model is configured to:
extract image features from the original character image by the image encoder;
extract sampling information features from sampling information of the original character image by the sampling information encoder;
perform channel concatenation on the image features and the sampling information features to obtain a channel concatenation result; and
generate a conversion result image by the decoder based on the channel concatenation result.

10. The method according to claim 3, wherein obtaining the typeface style conversion network comprises:
obtaining a pre-trained initial typeface style conversion network, wherein the initial typeface style conversion network comprises a second generative adversarial network, and the second generative adversarial network comprises an initial generative model and an initial discriminative model, wherein the initial generative model is configured to generate a second conversion initial image for a second original character image, and the initial discriminative model is configured to predict the probability that the second conversion initial image is a target character image; and
wherein converting the initial typeface style conversion network into the preset typeface style conversion network comprising:
adding a sampling information encoder to the initial generative model of the initial typeface style conversion network, wherein the sampling information encoder is configured to encode sampling information of an original character image,
cascading an output of the sampling information encoder to an input of a decoder in the initial generative model to obtain the generative model, and
determining the initial discriminative model as the discriminative model.

11. The method according to claim 10, wherein obtaining the pre-trained initial typeface style conversion network comprises: training the initial typeface style conversion network to obtain the pre-trained initial typeface style conversion network; wherein training the initial typeface style conversion network comprises:
obtaining an initial character image sample set, wherein the initial character image sample set comprises second character image samples, and each of the second character image samples comprises a second original character image and a second target character image, wherein the second original character image serves as a sample feature, the second target character image serves as a sample label, and the second original character image and the second target character image in the same second character image sample represent the same character; and
using the initial character image sample set to train the initial typeface style conversion network.

12. The method according to claim 11, wherein the second original character image comprises a character image in a handwritten style, and the second target character image comprises a character image in a printed typeface style.

13. The method according to claim 3, wherein the multiple first target character images representing the same character have different typeface styles; wherein the generative model in the target typeface style conversion network is configured to: for inputs of different character images representing the same character, output conversion result character images with different typeface styles.

14. The method according to claim 2, further comprising:
determining different character images representing the same character and having different typeface styles as multiple first target character images; and
according to the multiple first target character images, respectively obtaining sample features to obtain the first character image samples.

15. The method according to claim 14, wherein respectively obtaining the sample features comprises:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a similarity as at least one first original character image, and determining sampling information for the at least one first original character image;
for any one of the multiple first target character images, obtaining at least one character image of copied writing, determining the at least one character image as at least one first original character image, and determining sampling information for the at least one first original character image; or
any combination thereof.

16. The method according to claim 3, wherein the multiple first target character images representing the same character have different handwritten styles; wherein the generative model in the target typeface style conversion network is configured to: for inputs of different character images representing the same character, output conversion result character images with different handwritten styles.

17. The method according to claim 2, further comprising:
determining different character images representing the same character and having different handwritten styles as multiple first target character images; and
respectively obtaining sample features according to the multiple first target character images, to obtain the first character image samples;
wherein obtaining the sample features respectively according to the first target character images comprises:
for any one of the multiple first target character images, obtaining at least one first original character image through image enhancement processing, and determining sampling information for the at least one first original character image;
for any one of the multiple first target character images, determining at least one character image each with an image similarity to the first target character image higher than a similarity as at least one first original character image, and determining sampling information for the at least one first original character image;
for any one of the multiple first target character images, obtaining at least one character image of copied writing, determining the at least one character image as at least one first original character image, and determining sampling information for the at least one first original character image;
for any one of the multiple first target character images, determining at least one character image obtained by handwriting a character represented by the first target character image in the same handwritten style as at least one first original character image, and determining sampling information for the at least one first original character image; or
any combination thereof.

18. (canceled)

19. The method according to claim 2, further comprising:
obtaining different character images handwritten by different individuals for the same character, wherein the different individuals have different handwritten styles, and for the same character, a number of character images obtained by handwriting the same character by the same individual based on the same handwritten style is greater than or equal to 2; and
determining any one of character images handwritten by the same individual as the first target character image, and determining other character images handwritten by the same individual as first original character images, and determining sampling information for the first original character images, to obtain character image samples.

20. A method comprising:
obtaining a to-be-converted character image and sampling information of the to-be-converted character image;
inputting the to-be-converted character image and the sampling information into a generative model in the target typeface style conversion network of claim 1; and
determining an output of the generative model as a conversion result character image;

21-25. (canceled)

26. An electronic device, comprising:
one or more processors; and
one or more memories communicatively connected to the one or more processors; wherein the one or more memories store instructions that can be executed by the one or more processors, and the one or more processors when executing the instructions implements:
obtaining a typeface style conversion network, wherein the typeface style conversion network comprises a generative adversarial network;
obtaining a character image sample set, wherein the character image sample set comprises first character image samples, and each of the first character image samples comprises a first original character image, sampling information of the first original character image, and a first target character image, wherein the first original character image and the sampling information of the first original character image serve as sample features, the first target character image serves as a sample label, and the first original character image and the first target character image in the same character image sample representing the same character; and
training the typeface style conversion network using the character image sample set to obtain a target typeface style conversion network.

27. A computer-readable storage medium storing a computer program, wherein the computer program when executed by a processor, implements:
obtaining a typeface style conversion network, wherein the typeface style conversion network comprises a generative adversarial network;
obtaining a character image sample set, wherein the character image sample set comprises first character image samples, and each of the first character image samples comprises a first original character image, sampling information of the first original character image, and a first target character image, wherein the first original character image and the sampling information of the first original character image serve as sample features, the first target character image serves as a sample label, and the first original character image and the first target character image in the same character image sample representing the same character; and
training the typeface style conversion network using the character image sample set to obtain a target typeface style conversion network.
